(19) United States
(12) Patent Application Publication
(10) Pub. No.: US 2023/0249257 A1
(43) Pub. Date: Aug. 10, 2023

(54) TOOL PATH OPTIMIZATION METHOD FOR MINIMIZING THERMAL UNBALANCE IN METAL 3D PRINTING

(71) Applicant: Korea Electronics Technology Institute, Seongnam-si (KR)

(72) Inventors: Hwa Seon SHIN, Yongin-si (KR); Sung Hwan CHUN, Seoul (KR); Hye In LEE, Anyang-si (KR); Sung Hun PARK, Seoul (KR)

(73) Assignee: Korea Electronics Technology Institute, Seongnam-si (KR)

(21) Appl. No.: 17/623,146

(22) PCT Filed: Nov. 3, 2021
(86) PCT No.: PCT/KR2021/015754

§ 371 Date: Dec. 27, 2021

(30) Foreign Application Priority Data
Nov. 25, 2020 (KR) 10-2020-0159488

(51) Int. Cl. B22F 10/85; B22F 10/368; B22F 10/366; B22F 12/90; B22F 10/28

(52) U.S. Cl. CPC B22F 10/85; B22F 10/368; B22F 10/366; B22F 12/90; B22F 10/28

(57) ABSTRACT

Provided is a tool path optimization method for minimizing thermal unbalance in metal 3D printing. The tool path optimization method according to an embodiment of the present disclosure includes: a slicing step of generating stratum data by slicing a 3D model; a tool path data generation step of generating tool path data including a moving path of a tool which is moved inside a stratum, by applying equipment settings to the generated stratum data; a thermal data generation step of generating thermal data A of a first stratum and thermal data B1, B2, B3 of three lower layers of the first stratum, based on the tool path data; a thermal data analysis step of generating a thermal data contour by combining the thermal data A, B1, B2, B3; a thermal data application step of identifying an area where thermal unbalance is concentrated based on the thermal data contour, and setting an identification area D; and a tool path optimization step of optimizing a tool path for the identification area D. Accordingly, by correcting and regenerating a tool path to minimize thermal unbalance, based on thermal data which is a result of simulating thermal unbalance occurring when metal additive manufacturing is performed, costs incurred in current metal 3D printing manufacturing sites may be saved.

### TECHNICAL FIELD

The present disclosure relates to metal 3D printing technology, and more particularly, to a method for optimizing a tool path for minimizing thermal unbalance in metal 3D printing.

### BACKGROUND ART

In the case of metal 3D printing, a 3D model may be sliced and stratum information may be generated as shown in FIGS. 1 and 2, and a tool path of a laser may be generated based on a shape of a layer surface included in the stratum information.

When the tool path is generated, a laser moves along the tool path while generating heat of 600-1600 degrees, and fuses metal powder, and an output is formed as the metal powder is coagulated.

In this case, when the laser moves, thermal unbalance may occur on a specific area. This is because of thermal conductivity of the metal, and, even if the laser does not directly heat, thermal unbalance may occur, causing a problem of degradation of output quality.

In the related-art technology, even when metal additive manufacturing is performed with the same material or under the same printing environment, the heat distribution changing with time varies according to a shape of a model to be outputted. Therefore, there are attempts to reduce thermal unbalance by changing a sequence, a direction of progress of the tool path, based on process operator's know-how, but this method may incur costs of time, material, manpower required to find a tool path for minimizing thermal unbalance, and a process operator who has no experience may have difficulty in making a metal additive manufacturing output having stabilized output quality.

### DISCLOSURE

### Technical Problem

The present disclosure has been developed in order to address the above-discussed deficiencies of the prior art, and an object of the present disclosure is to provide a tool path optimization method for minimizing thermal unbalance, by considering heat distribution on a currently outputted layer and heat distribution of residual heat remaining on already outputted lower layers, through simulated thermal data.

### Technical Solution

According to an embodiment of the present disclosure to achieve the above-described object, a tool path optimization method may include: a slicing step of generating stratum data by slicing a 3D model; a tool path data generation step of generating tool path data including a moving path of a tool which is moved inside a stratum, by applying equipment settings to the generated stratum data; a thermal data generation step of generating thermal data A of a first stratum and thermal data B1, B2, B3 of three lower layers of the first stratum, based on the tool path data; a thermal data analysis step of generating a thermal data contour by combining the thermal data A, B1, B2, B3; a thermal data application step of identifying an area where thermal unbalance is concentrated based on the thermal data contour, and setting an identification area D; and a tool path optimization step of optimizing a tool path for the identification area D.

In addition, the slicing step may include generating a 2D polygon which is stratum data having a thickness of a Z-axis gap by slicing the 3D model by the predetermined Z-axis gap.

In addition, the tool path data generation step may include, when a parameter for setting at least one of a pattern shape, a pattern size, a hatching gap, and a hatch length is inputted, generating a moving path of a tool moving in the 2D polygon which is the stratum data, by applying the inputted parameter.

In addition, the tool path data generation step may include: when the moving path of the tool is generated, generating tool path data for really outputting, by reflecting adjustment information of the generated moving path of the tool and a metal 3D printer component; and calculating a time required when the 2D polygon of the first stratum is outputted, through the generated tool path data.

In addition, the thermal data generation step may include: generating thermal data A regarding an entire area of the first stratum, based on the tool path data, and storing the generated thermal data A and the required time of the first stratum calculated; and generating thermal data B1, B2, B3 from pre-stored respective thermal data regarding the three lower layers of the first stratum, by considering a heat loss which occurs when a time corresponding to the required time of the first stratum is elapsed.

In addition, the thermal data analysis step may include applying respective weights to the thermal data A, B1, B2, B3 before combining the generated thermal data A, B1, B2, B3, and the total sum of the respective weights applied to the thermal data A, B1, B2, B3 may be 1.

In addition, the thermal data analysis step may include combining the thermal data to which the weights are applied, and generating a thermal data contour for identifying thermal unbalance areas by binding sections belonging to a specific range within the combined thermal data C, and applying the generated thermal data contour to the 2D polygon.

In addition, the thermal data application step may include: matching the thermal data C in which the thermal unbalance areas are identified, with the tool path data; analyzing in which area of the four quartiles of divided areas in the tool path data thermal balance occurs, by comparing the area identified as a thermal unbalance area in the thermal data C and the divided areas (pattern) in the tool path data; and generating the identification area D by identifying the area where thermal unbalance is concentrated in the tool path data.

In addition, the tool path optimization step may include correcting a tool path pattern, changing a progress sequence, or adjusting a laser speed in a specific section in order to minimize thermal unbalance in the identification area D.

According to another embodiment of the present disclosure, a tool path optimization system may include: an input unit configured to input a parameter for setting equipment; and a processor configured to: generate stratum data by slicing a 3D model; generate tool path data including a moving path of a tool which is moved inside a stratum, by applying equipment settings to the generated stratum data; generate thermal data A of a first stratum and thermal data B1, B2, B3 of three lower layers of the first stratum, based on the tool path data; generate a thermal data contour by combining the thermal data A, B1, B2, B3; identify an area where thermal unbalance is concentrated based on the thermal data contour and to set an identification area D; and optimize a tool path for the identification area D.

In addition, according to still another embodiment of the present disclosure, a tool path optimization method may include: a tool path data generation step of generating tool path data including a moving path of a tool which is moved inside a stratum, by applying equipment settings to stratum data; a thermal data generation step of generating thermal data A of a first stratum and thermal data B1, B2, B3 of three lower layers of the first stratum, based on the tool path data; a thermal data analysis step of generating a thermal data contour by combining the thermal data A, B1, B2, B3; a thermal data application step of identifying an area where thermal unbalance is concentrated based on the thermal data contour, and setting an identification area D; and a tool path optimization step of optimizing a tool path for the identification area D.

In addition, according to yet another embodiment of the present disclosure, a computer-readable recording medium may have a program recorded thereon to perform a tool path optimization method, the method including: a tool path data generation step of generating tool path data including a moving path of a tool which is moved inside a stratum, by applying equipment settings to stratum data; a thermal data generation step of generating thermal data A of a first stratum and thermal data B1, B2, B3 of three lower layers of the first stratum, based on the tool path data; a thermal data analysis step of generating a thermal data contour by combining the thermal data A, B1, B2, B3; a thermal data application step of identifying an area where thermal unbalance is concentrated based on the thermal data contour, and setting an identification area D; and a tool path optimization step of optimizing a tool path for the identification area D.

### Advantageous Effects

According to embodiments of the present disclosure as described above, by correcting and regenerating a tool path to minimize thermal unbalance, based on thermal data which is a result of simulating thermal unbalance occurring when metal additive manufacturing is performed, costs incurred in current metal 3D printing manufacturing sites may be saved.

### DESCRIPTION OF DRAWINGS

FIG. 1 is a view provided to explain metal 3D printing which uses metal powder;

FIG. 2 is a view provided to explain a metal 3D printing process which uses metal powder;

FIG. 3 is a flowchart provided to explain a tool path optimization method according to an embodiment of the present disclosure;

FIG. 4 is a view provided to explain the tool path optimization method of FIG. 3;

FIG. 5 is a view provided to explain a tool path data generation process;

FIG. 6 is a view provided to explain a thermal data analysis process;

FIG. 7 is a view provided to explain a thermal data application process and a tool path optimization process; and

FIG. 8 is a view provided to explain a tool path optimization system according to an embodiment of the present disclosure.

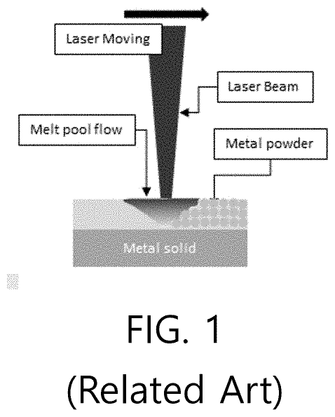

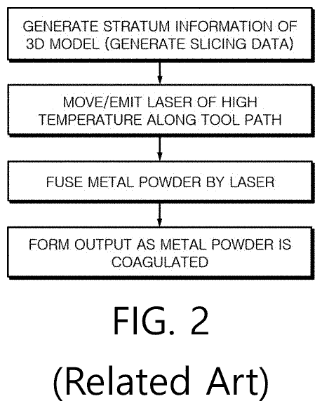

### BEST MODE

Hereinafter, the present disclosure will be described in more detail with reference to the drawings.

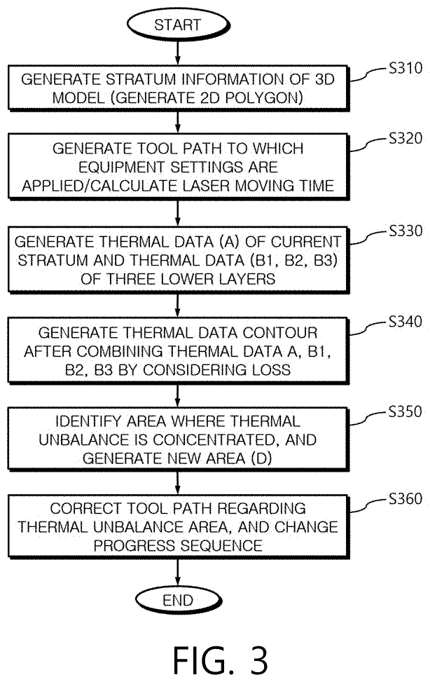

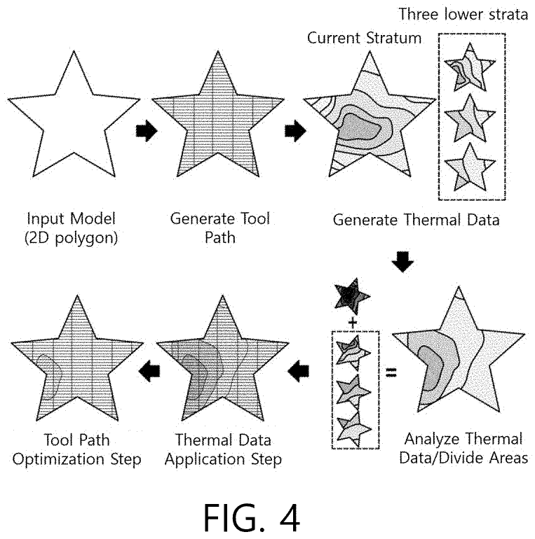

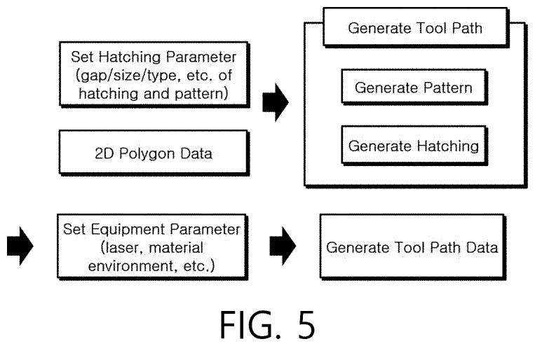

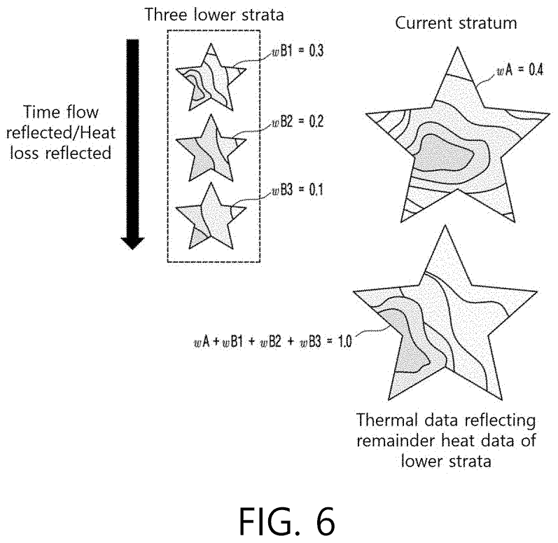

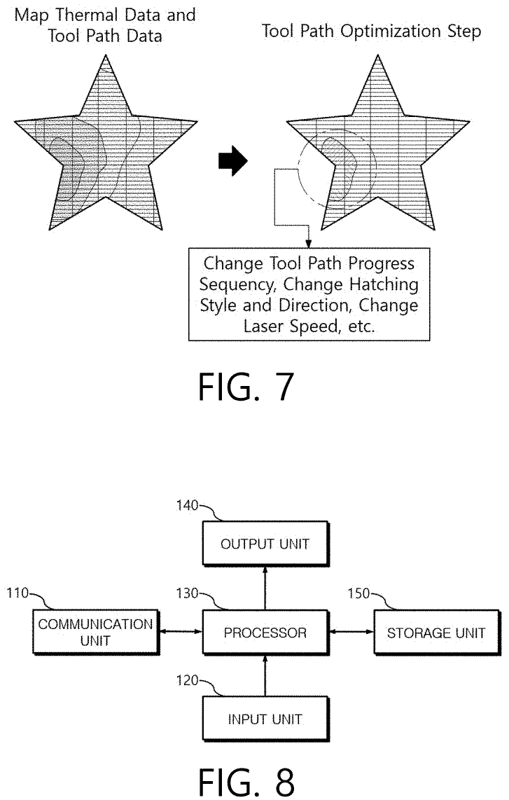

FIG. 3 is a flowchart provided to explain a tool path optimization method according to an embodiment of the present disclosure, FIG. 4 is a view provided to explain the tool path optimization method of FIG. 3, and FIG. 5 is a view provided to explain a tool path data generation process. In addition, FIG. 6 is a view provided to explain a thermal data analysis process, and FIG. 7 is a view provided to explain a thermal data application process and a tool path optimization process.

The tool path optimization method according to the present embodiment is provided to minimize thermal unbalance by considering heat distribution of a layer which is being currently outputted, and heat distribution of residual heat remaining on lower layers which are already outputted, through simulated thermal data.

Specifically, the tool path optimization method of the present disclosure is to generate a tool path for reducing thermal unbalance, which is caused by a laser during metal additive manufacturing, by correcting a tool path, which is a moving path of the laser, based on simulated thermal data.

In the field of metal 3D printing technology, a plurality of attempts to output are required to stabilize a tool path which varies according to a shape of a 3D model. The tool path optimization method of the present disclosure may predict an area where thermal unbalance may occur, based on thermal data which is simulated with respect to a tool path generated based on a 2D polygon on a layer, and may regenerate a tool path for minimizing thermal unbalance by correcting the tool path, thereby reducing an output failure rate generated to stabilize the tool path and thus reducing an additive manufacturing cost.

To achieve this, the tool path optimization method of the present disclosure may include: a slicing step (S310) of generating stratum data by slicing a 3D model; a tool path data generation step (S320) of generating tool path data including a moving path of a tool which is moved inside a stratum, by applying equipment settings to the generated stratum data; a thermal data generation step (S330) of generating thermal data A of a first stratum and thermal data B1, B2, B3 of three lower layers of the first stratum, based on the tool path data; a thermal data analysis step (S340) of generating a thermal data contour by combining the thermal data A, B1, B2, B3; a thermal data application step (S350) of identifying an area where thermal unbalance is concentrated based on the thermal data contour, and setting an identification area D; and a tool path optimization step (S360) of optimizing a tool path for the identification area D.

At the slicing step S310, the method may generate a 2D polygon which is stratum data having a thickness of a Z-axis gap by slicing the 3D model by the predetermined Z-axis gap.

At the tool path data generation step (S320), when a parameter for setting at least one of a pattern shape, a pattern size, a hatching gap, and a hatch length is inputted, the method may generate a moving path of a tool moving in the 2D polygon which is the stratum data, by applying the inputted parameter.

In addition, at the tool path data generation step (S320), when the moving path of the tool is generated, the method may generate tool path data for really outputting, by reflecting adjustment information of the generated moving path of the tool and a metal 3D printer component, and may calculate a time required when the 2D polygon of the first stratum is outputted, through the generated tool path data.

Specifically, at the tool path data generation step (S320), the method may receive a parameter, such as a pattern shape, a pattern size, a hatching gap, and a hatch length for adjusting the tool path, from a processor operator, as shown in FIG. 5, and, when an equipment parameter is set, the method may apply the set parameter and may generate a moving path of a laser moving inside the 2D polygon.

In addition, at the tool path data generation step (S320), after the tool path is generated, the method may generate tool path data for really outputting with adjustment information of a metal 3D printer component such as a laser, and may calculate a time required when the 2D polygon of a corresponding layer is outputted, through the tool path data.

At the thermal data generation step (S330), the method may generate thermal data A regarding an entire area of the first stratum, based on the tool path data, and may store the generated thermal data A and a required time of the first stratum calculated, and may generate thermal data B1, B2, B3 from pre-stored respective thermal data regarding three lower layers of the first stratum, by considering a heat loss which occurs when a time corresponding to the required time of the first stratum is elapsed.

At the thermal data analysis step (S340), the method may apply respective weights to the thermal data A, B1, B2, B3 before combining the generated thermal data A, B1, B2, B3, as shown in FIG. 6.

In this case, the total sum of the respective weights applied to the thermal data A, B1, B2, B3 is 1 as follows:

Total Weight=wA+wB1+wB2+wB3

In addition, at the thermal data analysis step (S340), the method may combine the thermal data to which the weights are applied, and may generate a thermal data contour for identifying thermal unbalance areas by binding sections belonging to a specific range within the combined thermal data C, and may apply the generated thermal data contour to the 2D polygon.

Specifically, at the thermal data analysis step (S340), the method may apply respective weights to the inputted thermal data A, B1, B2, B3, and may obtain the sum C of the thermal data to which the weights are applied, and then, may generate a heat-based contour for identifying thermal unbalance areas by binding sections belonging to a specific range within the thermal data C. In addition, the method may apply the heat-based contour to the 2D polygon and may divide areas of the 2D polygon corresponding to the contour.

At the thermal data application step (S350), the method may match the thermal data C in which the thermal unbalance areas are identified, with the tool path data, may analyze in which area of the four quartiles of divided areas in the tool path data thermal balance occurs, by comparing the area identified as a thermal unbalance area in the thermal data C and the divided areas (pattern) in the tool path data, and may generate the identification area D by identifying the area where thermal unbalance is concentrated in the tool path data.

At the tool path optimization step (S360), the method may correct a tool path pattern, may change a progress sequence, or may adjust a laser speed in a specific section in order to minimize thermal unbalance in the identification area D.

For example, at the tool path optimization step (S360), when the identification area D is generated within the first stratum, the method may adjust to relatively increase a moving speed of a laser moving along the tool path, and to increase an output pattern interval of the laser as the moving path gets closer to a reference point, which is the center of the identification area D.

Through this, by correcting and regenerating a tool path to minimize thermal unbalance, based on thermal data which is a result of simulating thermal unbalance occurring when metal additive manufacturing is performed, costs incurred in current metal 3D printing manufacturing sites may be saved.

FIG. 8 is a view provided to explain a tool path optimization system according to an embodiment of the present disclosure.

Referring to FIG. 8, the tool path optimization system includes a communication unit 110, an input unit 120, a processor 130, an output unit 140, and a storage unit 150.

The communication unit 110 is a means for communicating with external devices including a 3D printer, and for accessing a server, a cloud, etc. through a network, and may transmit/receive/upload/download data necessary for 3D printing.

The input unit 120 is a means for receiving an input of a parameter, etc. for setting equipment.

The processor 130 may perform the tool path optimization method described above with reference to FIGS. 3 to 7.

Specifically, the processor 130 may generate stratum data by slicing a 3D model, may generate tool path data including a moving path of a tool which is moved inside a stratum, by applying equipment settings to the generated stratum data, may generate thermal data A of a first stratum and thermal data B1, B2, B3 of three lower layers of the first stratum, based on the tool path data, may generate a thermal data contour by combining the thermal data A, B1, B2, B3, may identify an area where thermal unbalance is concentrated based on the thermal data contour and may set an identification area D, and may optimize a tool path for the identification area D.

The output unit 140 is a display that outputs information generated/processed by the processor 130 to a screen, and the storage unit 150 is a storage medium that provides a storage space necessary for normally operating the processor 130.

The storage unit 150 may store stratum data of each of layers which are generated by slicing the 3D model, and a time required to output a 2D polygon on each stratum.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

1. A tool path optimization method comprising:
a slicing step of generating stratum data by slicing a 3D model;
a tool path data generation step of generating tool path data comprising a moving path of a tool which is moved inside a stratum, by applying equipment settings to the generated stratum data;
a thermal data generation step of generating thermal data A of a first stratum and thermal data B1, B2, B3 of three lower layers of the first stratum, based on the tool path data;
a thermal data analysis step of generating a thermal data contour by combining the thermal data A, B1, B2, B3;
a thermal data application step of identifying an area where thermal unbalance is concentrated based on the thermal data contour, and setting an identification area D; and
a tool path optimization step of optimizing a tool path for the identification area D.

2. The method of claim 1, wherein the slicing step comprises generating a 2D polygon which is stratum data having a thickness of a Z-axis gap by slicing the 3D model by the predetermined Z-axis gap.

3. The method of claim 1, wherein the tool path data generation step comprises, when a parameter for setting at least one of a pattern shape, a pattern size, a hatching gap, and a hatch length is inputted, generating a moving path of a tool moving in the 2D polygon which is the stratum data, by applying the inputted parameter.

4. The method of claim 3, wherein the tool path data generation step comprises:
when the moving path of the tool is generated, generating tool path data for really outputting, by reflecting adjustment information of the generated moving path of the tool and a metal 3D printer component; and
calculating a time required when the 2D polygon of the first stratum is outputted, through the generated tool path data.

5. The method of claim 4, wherein the thermal data generation step comprises:
generating thermal data A regarding an entire area of the first stratum, based on the tool path data, and storing the generated thermal data A and the required time of the first stratum calculated; and
generating thermal data B1, B2, B3 from pre-stored respective thermal data regarding the three lower layers of the first stratum, by considering a heat loss which occurs when a time corresponding to the required time of the first stratum is elapsed.

6. The method of claim 5, wherein the thermal data analysis step comprises applying respective weights to the thermal data A, B1, B2, B3 before combining the generated thermal data A, B1, B2, B3, and
wherein the total sum of the respective weights applied to the thermal data A, B1, B2, B3 is 1.

7. The method of claim 6, wherein the thermal data analysis step comprises combining the thermal data to which the weights are applied, and generating a thermal data contour for identifying thermal unbalance areas by binding sections belonging to a specific range within the combined thermal data C, and applying the generated thermal data contour to the 2D polygon.

8. The method of claim 7, wherein the thermal data application step comprises matching the thermal data C in which the thermal unbalance areas are identified, with the tool path data, analyzing in which area of the four quartiles of divided areas in the tool path data thermal balance occurs, by comparing the area identified as a thermal unbalance area in the thermal data C and the divided areas (pattern) in the tool path data, and generating the identification area D by identifying the area where thermal unbalance is concentrated in the tool path data.

9. The method of claim 8, wherein the tool path optimization step comprises correcting a tool path pattern, changing a progress sequence, or adjusting a laser speed in a specific section in order to minimize thermal unbalance in the identification area D.

10. A tool path optimization system comprising:
an input unit configured to input a parameter for setting equipment; and
a processor configured to: generate stratum data by slicing a 3D model; generate tool path data comprising a moving path of a tool which is moved inside a stratum, by applying equipment settings to the generated stratum data; generate thermal data A of a first stratum and thermal data B1, B2, B3 of three lower layers of the first stratum, based on the tool path data; generate a thermal data contour by combining the thermal data A, B1, B2, B3; identify an area where thermal unbalance is concentrated based on the thermal data contour and to set an identification area D; and optimize a tool path for the identification area D.

11. A tool path optimization method comprising:
a tool path data generation step of generating tool path data comprising a moving path of a tool which is moved inside a stratum, by applying equipment settings to stratum data;
a thermal data generation step of generating thermal data A of a first stratum and thermal data B1, B2, B3 of three lower layers of the first stratum, based on the tool path data;
a thermal data analysis step of generating a thermal data contour by combining the thermal data A, B1, B2, B3;
a thermal data application step of identifying an area where thermal unbalance is concentrated based on the thermal data contour, and setting an identification area D; and
a tool path optimization step of optimizing a tool path for the identification area D.

12. A computer-readable recording medium having a program recorded thereon to perform a tool path optimization method, the method comprising:
a tool path data generation step of generating tool path data comprising a moving path of a tool which is moved inside a stratum, by applying equipment settings to stratum data;
a thermal data generation step of generating thermal data A of a first stratum and thermal data B1, B2, B3 of three lower layers of the first stratum, based on the tool path data;
a thermal data analysis step of generating a thermal data contour by combining the thermal data A, B1, B2, B3;
a thermal data application step of identifying an area where thermal unbalance is concentrated based on the thermal data contour, and setting an identification area D; and
a tool path optimization step of optimizing a tool path for the identification area D.
